(19) United States
(12) Patent Application Publication
(10) Pub. No.: US 2026/0218952 A1
(43) Pub. Date: Jul. 30, 2026

(54) HEAT MANAGEMENT FLUID MODULE FOR VEHICLE

(71) Applicant: HANON SYSTEMS, Daejeon (KR)

(72) Inventors: In Keun KANG, Daejeon (KR); Kyeong Cheol LEE, Daejeon (KR); Jae Min LEE, Daejeon (KR); Chan Jin LEE, Daejeon (KR); Seung Kyu OH, Daejeon (KR); Young Wook CHO, Daejeon (KR)

(21) Appl. No.: 19/149,312

(22) PCT Filed: Mar. 15, 2024
(86) PCT No.: PCT/KR2024/003289

§ 371 Date: Jul. 18, 2025

(30) Foreign Application Priority Data
Mar. 20, 2023 (KR) 10-2023-0035689
Apr. 20, 2023 (KR) 10-2023-0052108
Apr. 20, 2023 (KR) 10-2023-0052150

(51) Int. Cl. F25B 41/42; F25B 41/325; F28D 21/00

(52) U.S. Cl. CPC F25B 41/42; F25B 41/325; F28D 2021/0068; F28D 2021/008

(57) ABSTRACT

A thermal management fluid module for a vehicle according to one embodiment comprises: a manifold plate in which a flow path on which fluid flows is formed; a heat exchanger coupled to one side of the manifold plate; and a valve which is coupled to the other side of the manifold plate, and which expands the fluid or controls the direction of the fluid, wherein the fluid flowing out from the heat exchanger can communicate with the valve so as to directly flow thereto.

### TECHNICAL FIELD

The present invention relates to a thermal management fluid module for a vehicle, and more specifically, to a thermal management fluid module for a vehicle, in which components such as a heat exchanger and valves are modularized into one.

### BACKGROUND ART

Under the trend of environmentally friendly industrial development and development of energy sources that replace fossil fuels, the most notable areas in the automobile industry these days are electric vehicles and hybrid vehicles. Electric vehicles and hybrid vehicles are equipped with batteries to provide a driving force, and the batteries are used for heating and cooling as well as driving.

In a vehicle that uses batteries to provide a driving force, the use of the batteries as a heat source for heating and cooling means that a driving distance is reduced by as much as the usage. To overcome the problem, a method of applying a heat management system, which has been widely used in household heating and cooling devices, to automobiles has been proposed.

For reference, a thermal management system performs absorbing low-temperature heat and transferring the absorbed heat to high-temperature heat. As an example, a thermal management system has a cycle in which a liquid fluid evaporates in an evaporator, takes heat from the surroundings, becomes gas, and then liquefies again by releasing heat to the surroundings through a condenser. When the thermal management system is applied to electric vehicles or hybrid vehicles, there is an advantage that it is possible to secure a heat source that is lacking in conventional air conditioning devices.

Currently, a modular configuration of the thermal management system for electric vehicles is formed in a partial modulization method that connects main components (valves, accumulators, chillers, condensers, internal heat exchangers, sensors, and the like) by pipes. In a development process of such a thermal management system for a vehicle, it is necessary to develop technologies that optimize modularization through appropriate arrangement of components, improvement of refrigerant flow paths, and the like.

### DETAILED DESCRIPTION OF INVENTION

### Technical Problem

The present invention is directed to providing a thermal management fluid module for a vehicle, in which optimal modularization is implemented by forming refrigerant flow paths and arranging heat exchangers, valves, and the like on one surface and the other surface of a manifold plate.

Further, the present invention is directed to providing a thermal management fluid module for a vehicle, which is capable of improving workability of a product and reducing production cost because the thermal management fluid module for a vehicle can be packaged due to refrigerant flowing through one surface of a manifold plate that passes through a main plate and directly flows into a valve.

Further, the present invention is directed to providing a thermal management fluid module for a vehicle, which is capable of minimizing pressure loss and thermal interference between flow paths, thereby preventing degradation of thermal management performance because the refrigerant flow paths are formed as short as possible by valves disposed on both surfaces of the manifold plate communicating with each other so that the refrigerant directly flows into the valves.

### Technical Solution

One aspect of the present invention provides a thermal management fluid module for a vehicle, including a manifold plate in which a flow path through which a fluid flows is formed, a heat exchanger coupled to one surface of the manifold plate, and a valve coupled to the other surface of the manifold plate and configured to expand the fluid or control a direction of the fluid, wherein the fluid discharged from the heat exchanger directly flows to the valve.

The manifold plate may include a main plate, a first plate that is coupled to one surface of the main plate and in which a flow path through which a fluid flows is formed, and a second plate that is coupled to the other surface of the main plate and in which a flow path through which a fluid flows is formed.

A communication hole for flow path communication between the heat exchanger and the valve which are respectively coupled to the first plate and the second plate may be formed in the main plate.

A fluid outlet through which the fluid is discharged from the heat exchanger may be disposed on an extension line that extends in a horizontal direction from a valve inlet through which the fluid is introduced from the valve.

A first heat exchanger which performs heat exchange while the fluid flows, and a first expansion valve that expands the fluid flowing into the first heat exchanger or passes the fluid may be coupled to the second plate.

A second heat exchanger which performs heat exchange while the fluid flows, a first direction changing valve and a second direction changing valve that control a direction of the fluid discharged from the first heat exchanger, and a second expansion valve that expands the fluid flowing into the second heat exchanger may be coupled to the first plate.

A first heat exchanger through which a high-temperature fluid flows may be coupled to the second plate, and a second heat exchanger through which a low-temperature fluid flows may be coupled to the first plate.

The first heat exchanger may be disposed so that the fluid directly flows to the first direction changing valve or the second direction changing valve.

A first refrigerant outlet of the first heat exchanger may be disposed on an extension line that extends in a horizontal direction from a valve inlet of the second direction changing valve.

The first heat exchanger may be a water-cooled condenser, and the second heat exchanger may be a chiller.

The first expansion valve and the first direction changing valve may be disposed on an extension line that extends in a horizontal direction from the manifold plate.

An accumulator port through which the fluid flows to an accumulator may be provided at a lowest end of the manifold plate in a direction of gravity.

Another aspect of the present invention provides a thermal management fluid module for a vehicle, including a manifold plate in which a flow path through which a fluid flows is formed, and a valve coupled to one surface of the manifold plate and configured to expand the fluid or control a direction of the fluid, wherein the fluid flowing in the other surface of the manifold plate flows directly into the valve coupled to the one surface of the manifold plate.

The manifold plate may includes a main plate, a first plate that is coupled to one surface of the main plate and in which a flow path through which a fluid flows is formed, and a second plate that is coupled to the other surface of the main plate and in which a flow path through which a fluid flows is formed.

A communication hole for flow path communication between the heat exchanger and the valve which are respectively coupled to the first plate and the second plate may be formed in the main plate.

The valve is seated and coupled on a valve mounting portion provided on the first plate, and an inlet hole that communicates with the communication hole may be formed in the valve mounting portion.

Outlet holes through which the fluid introduced through the inlet hole is discharged may be formed on both sides of the valve mounting portion.

A first heat exchanger which performs heat exchange while the fluid flows, and a first expansion valve that expands the fluid flowing into the first heat exchanger or passes the fluid may be coupled to the second plate.

A second heat exchanger which performs heat exchange while the fluid flows, a first direction changing valve and a second direction changing valve that control the direction of the fluid discharged from the first heat exchanger, and a second expansion valve that expands the fluid flowing into the second heat exchanger may be coupled to the first plate.

A first heat exchanger through which a high-temperature fluid flows may be coupled to the second plate, and a second heat exchanger through which a low-temperature fluid flows may be coupled to the first plate.

The first heat exchanger may be a water-cooled condenser, and the second heat exchanger may be a chiller.

The first expansion valve and a first direction changing valve may be disposed on an extension line that extends in a horizontal direction from the manifold plate.

An accumulator port through which the fluid flows to an accumulator may be provided at a lowest end of the manifold plate in a direction of gravity.

Still another aspect of the present invention provides a thermal management fluid module for a vehicle, including a manifold plate in which a flow path through which a fluid flows is formed, a heat exchanger that is coupled to one surface of the manifold plate and which performs heat exchange while the fluid flows, and a valve coupled to the one surface of the manifold plate and configured to expand the fluid or control a direction of the fluid, wherein the fluid flowing in the other surface of the manifold plate flows directly into the valve coupled to the one surface of the manifold plate.

The manifold plate may include a main plate, a first plate that is coupled to one surface of the main plate and in which a flow path through which a fluid flows is formed, and a second plate that is coupled to the other surface of the main plate and in which a flow path through which a fluid flows is formed.

A communication hole for flow path communication between the heat exchanger and the valve which are respectively coupled to the first plate and the second plate may be formed in the main plate.

The valve may be seated and coupled on a valve mounting portion provided on the first plate, and an inlet hole that communicates with the communication hole may be formed in the valve mounting portion.

Outlet holes through which the fluid introduced through the inlet hole is discharged may be formed on both sides of the valve mounting portion.

The valve may be seated and coupled on a valve mounting portion provided on the first plate, and an inlet hole through which the fluid is introduced may be formed at one side of the valve mounting portion.

An outlet hole that communicates with the communication hole may be formed in the valve mounting portion.

The heat exchanger may include a first heat exchanger and a second heat exchanger which are coupled to the first plate and perform heat exchange while the fluid flows.

A first expansion valve that expands the fluid flowing into the first heat exchanger or passes the fluid therethrough, a first direction changing valve and a second direction changing valve that control a direction of the fluid discharged from the first heat exchanger, and a second expansion valve that expands the fluid flowing into the second heat exchanger may be coupled to the first plate.

The first heat exchanger may be a water-cooled condenser, and the second heat exchanger may be a chiller.

A sensor that measures a temperature and pressure of the fluid may be coupled to the one surface of the manifold plate.

### Advantageous Effects

According to one embodiment of the present invention, it is possible to implement optimal modularization by forming refrigerant flow paths and arranging heat exchangers, valves, and the like on one surface and the other surface of a manifold plate.

According to one embodiment of the present invention, it is possible to package the thermal management fluid module for a vehicle because refrigerant flowing through one surface of a manifold plate can pass through a main plate and directly flow into a valve, thereby improving workability of a product and reducing production cost.

According to one embodiment of the present invention, it is possible to minimize pressure loss and thermal interference between flow paths, thereby preventing degradation of thermal management performance because the refrigerant flow paths are formed as short as possible by valves disposed on both surfaces of the manifold plate communicating with each other so that the refrigerant directly flows into the valves.

### DESCRIPTION OF DRAWINGS

FIG. 1 is a perspective view illustrating a thermal management fluid module for a vehicle according to an embodiment of the present invention.

FIG. 2 is an exploded perspective view illustrating a manifold plate of the thermal management fluid module for a vehicle according to the embodiment of the present invention.

FIG. 3 is a rear view illustrating the manifold plate of the thermal management fluid module for a vehicle according to the embodiment of the present invention.

FIG. 4 is a perspective view illustrating a second plate of the thermal management fluid module for a vehicle according to the embodiment of the present invention.

FIG. 5 is a perspective view illustrating a first heat exchanger of the thermal management fluid module for a vehicle according to the embodiment of the present invention.

FIG. 6 is a perspective view illustrating a second heat exchanger of the thermal management fluid module for a vehicle according to the embodiment of the present invention.

FIG. 7 is a front view illustrating the thermal management fluid module for a vehicle according to the embodiment of the present invention.

FIG. 8 is a side view illustrating the thermal management fluid module for a vehicle according to the embodiment of the present invention.

FIG. 9 is a drawing illustrating a fluid path between the first heat exchanger and the second direction changing valve in the thermal management fluid module for a vehicle according to the embodiment of the present invention.

FIG. 10 is a drawing illustrating a fluid flow path between valves in the thermal management fluid module for a vehicle according to the embodiment of the present invention.

FIG. 11 is a cross-sectional view illustrating the thermal management fluid module for a vehicle equipped with a first direction changing valve according to one embodiment of the present invention.

FIG. 12 is a perspective view illustrating a thermal management fluid module for a vehicle according to another embodiment of the present invention.

FIG. 13 is a perspective view illustrating a rear surface of a thermal management fluid module for a vehicle according to another embodiment of the present invention.

FIG. 14 is a side view of the thermal management fluid module for a vehicle according to another embodiment of the present invention.

FIG. 15 is a perspective view illustrating a first heat exchanger of the thermal management fluid module for a vehicle according to another embodiment of the present invention.

FIG. 16 is a perspective view illustrating a second heat exchanger of the thermal management fluid module for a vehicle according to another embodiment of the present invention.

FIG. 17 is a cross-sectional view illustrating an example of the thermal management fluid module for a vehicle equipped with a first direction changing valve according to another embodiment of the present invention.

FIG. 18 is a cross-sectional view illustrating another example of the thermal management fluid module for a vehicle equipped with the first direction changing valve according to another embodiment of the present invention.

### MODES OF THE INVENTION

The present invention may be modified in various ways and has various embodiments. Specific embodiments are illustrated in the drawings and will be described in detail. However, this is not intended to limit the present invention to the specific embodiments, but should be understood to include all transformations, equivalents, or substitutes included in the spirit and technical scope of the present invention. In explaining the present invention, when it is determined that a detailed description of a related known technology may obscure the gist of the present invention, the detailed description will be omitted.

The terms “first,” “second,” etc., may be used to describe various components, but the components should not be limited by the terms. The terms are used only to distinguish one component from another.

Terminology used in this application is only used to describe specific embodiments and is not intended to limit the present invention. The singular expression includes the plural expression unless the context clearly indicates otherwise. In this application, it should be understood that terms such as “include” and “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, throughout the specification, “connected” does not only mean that two or more components are directly connected, but may also mean that two or more components are indirectly connected through another component, that two or more components are electrically connected as well as physically connected, or that two or more components are integrally formed although they are referred to different names according to a location or function.

Hereinafter, embodiments of a thermal management fluid module for a vehicle according to the present invention will be described in detail with reference to the attached drawings, and when explaining with reference to the attached drawings, identical or corresponding components are assigned the same reference numbers, and redundant descriptions thereof will be omitted.

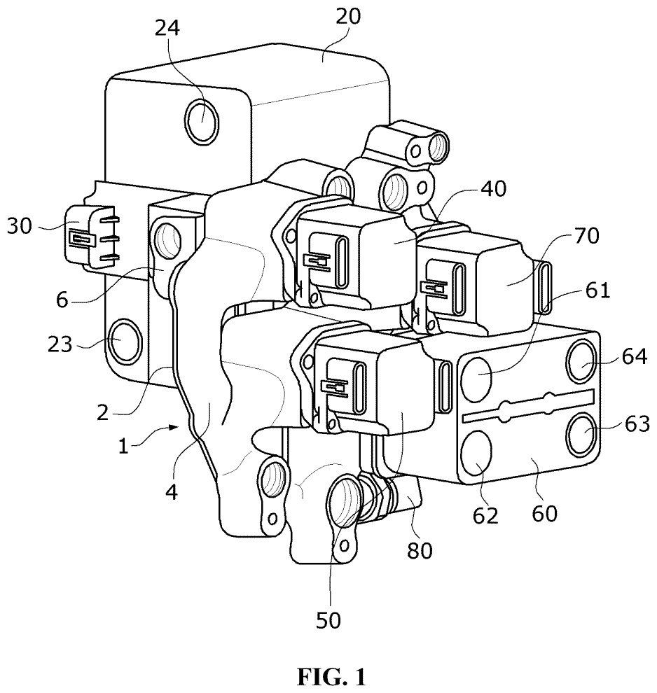

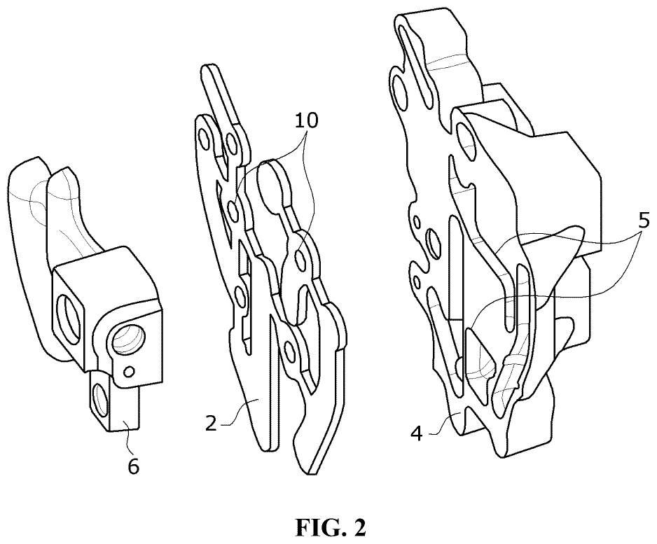

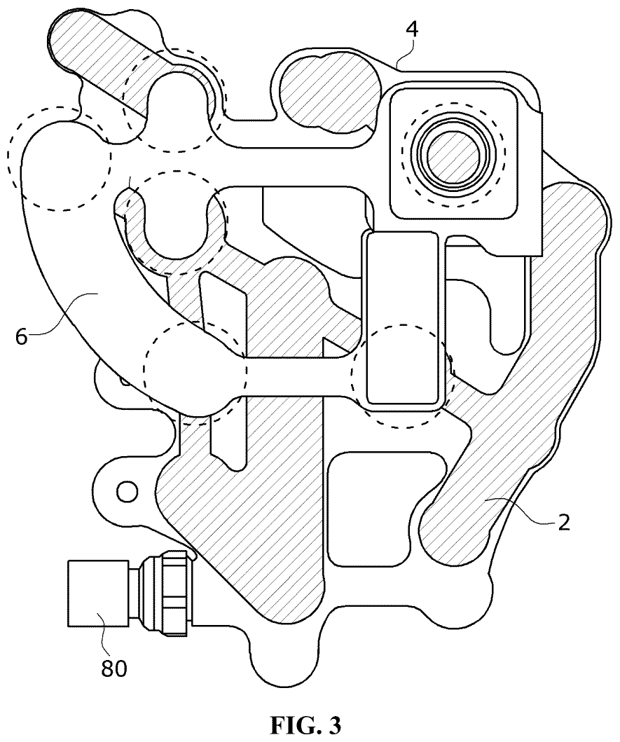

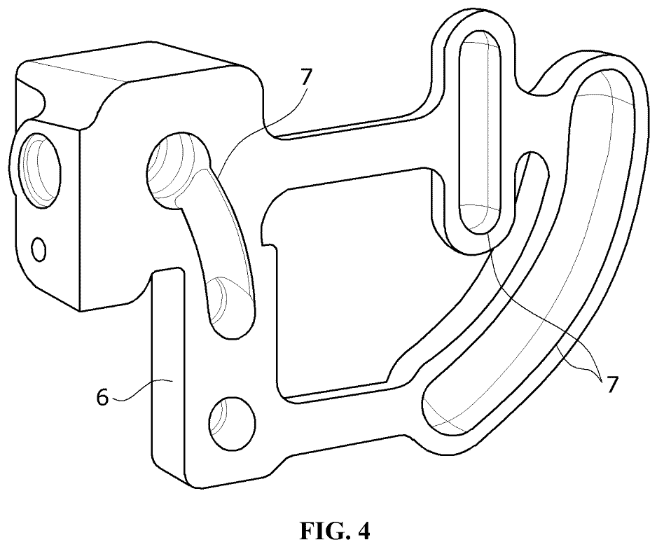

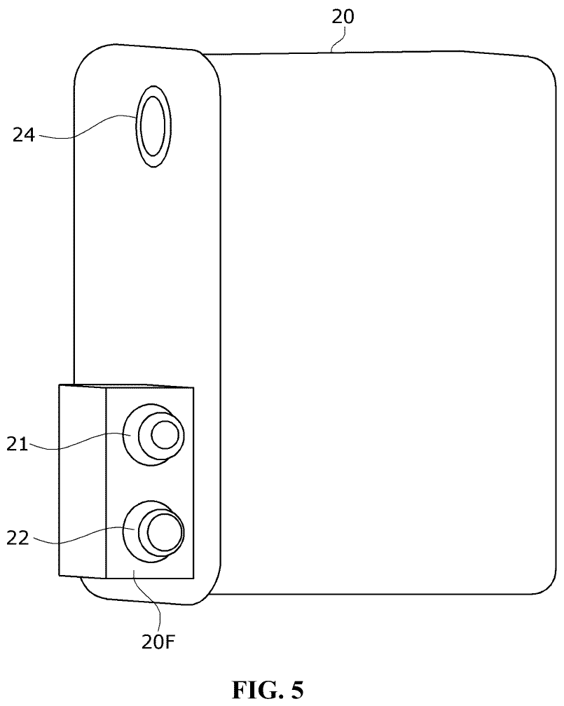

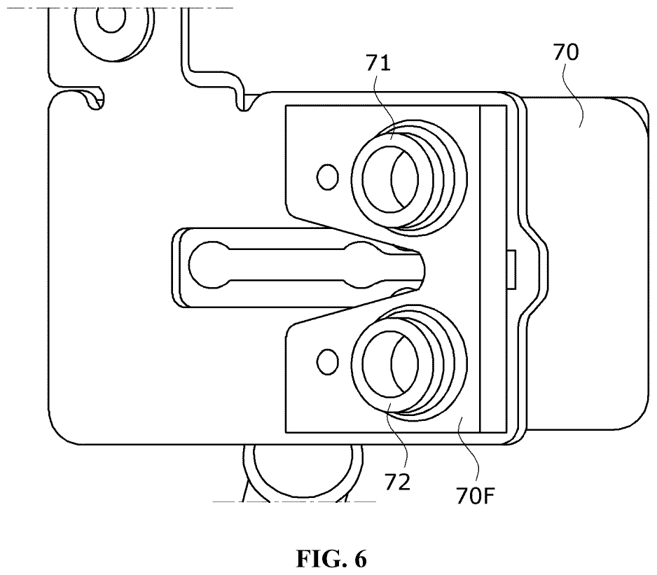

FIG. 1 is a perspective view illustrating a thermal management fluid module for a vehicle according to an embodiment of the present invention, FIG. 2 is an exploded perspective view illustrating a manifold plate of the thermal management fluid module for a vehicle according to the embodiment of the present invention, FIG. 3 is a rear view illustrating the manifold plate of the thermal management fluid module for a vehicle according to the embodiment of the present invention, FIG. 4 is a perspective view illustrating a second plate of the thermal management fluid module for a vehicle according to the embodiment of the present invention, FIG. 5 is a perspective view illustrating a first heat exchanger of the thermal management fluid module for a vehicle according to the embodiment of the present invention, and FIG. 6 is a perspective view illustrating a second heat exchanger of the thermal management fluid module for a vehicle according to the embodiment of the present invention.

According to the drawings, the thermal management fluid module for a vehicle according to the embodiment of the present invention includes a manifold plate 1 in which a flow path for a fluid to flow is formed, and valves that are respectively coupled to one surface and the other surface of the manifold plate 1 and expand the fluid or control a direction of the fluid, and the fluid discharged from the valve coupled to the one surface of the manifold plate 1 may communicate with the valve coupled to the other surface of the manifold plate 1 to directly flow thereto.

The manifold plate 1 has substantially a plate shape with a predetermined thickness and a fluid path formed therein. In this way, a first heat exchanger 20 and a second heat exchanger, expansion valves 30 and 70, and direction changing valves 40 and 50 60 which are heat exchange devices of a heat management system are coupled and modularized in the manifold plate 1, thereby reducing a manufacturing work of a product and reducing a work of a vehicle assembly line. In addition, the manifold plate 1 performs functions of piping, fitting and housing simultaneously, thereby reducing production cost and improving workability.

Referring to FIG. 2, the manifold plate 1 may include a main plate 2, a first plate 4 that is coupled to one surface of the main plate 2 and in which a first flow path 5 through which a fluid flows is formed, and a second plate 6 that is coupled to the other surface of the main plate 2 and in which a second flow path 7 through which a fluid flows is formed. The manifold plate 1 includes an assembly configured of the plates described above and can be manufactured by coupling the plates using brazing, structural adhesives, gaskets, or the like. Additionally, various materials such as aluminum, thermoplastic, stainless steel, and the like may be applied to the manifold plate 11 according to manufacturing methods, and purposes and functions thereof.

The main plate 2 is formed in a plate shape, and the first plate 4 may be coupled to the one surface of the main plate 2, and the second plate 6 may be coupled to the other surface. A fluid flow path is formed between the main plate 2 and a part formed by coupling the first plate 4 and the second plate 6 to protrude to a predetermined thickness. According to the manifold plate 1 formed by the coupling, the heat exchangers, the valves, and the like may be coupled to both surfaces of the main plate 2, the fluid flow paths may be formed, and modularization of components is possible in a more compact space.

Referring to FIGS. 2 to 4, the first flow path 5 through which a refrigerant flows may be formed inside the first plate 4, and the second flow path 7 through which a refrigerant flows may be formed inside the second plate 6. Accordingly, a flow of the refrigerant is possible in the first plate 4 and the second plate 6 disposed on both sides of the main plate 2.

A communication hole 10 for flow path communication between the valves connected to the first plate 4 and the second plate 6 may be formed in the main plate 2. The communication hole 10 may be formed anywhere other than in the portion illustrated in the drawing, as long as it is a portion through which refrigerant flow paths between the valves communicate with each other.

Referring again to FIG. 1, the first heat exchanger 20 and the first expansion valve 30 are coupled to the one surface (a left surface in the drawing) of the manifold plate 1, and the second heat exchanger 60, the first direction changing valve 40, the second direction changing valve 50, and the second expansion valve 70 are coupled to the other surface (a right surface in the drawing). That is, the second heat exchanger 60, the first direction changing valve 40, and the second direction changing valve 50 are coupled to the first plate 4, and the first heat exchanger 20 and the second expansion valve 30 are coupled to the second plate 6.

A flow path through which the refrigerant heat-exchanged in the first heat exchanger 20 flows into the first direction changing valve 40 may be a high-temperature flow path, and a path through which the refrigerant heat-exchanged in the second heat exchanger 60 is discharged may be a low-temperature flow path. However, as described above, when the first heat exchanger 20 and the second heat exchanger 60 are respectively disposed on one surface and the other surface of the manifold plate 1, the high-temperature flow path and the low-temperature flow path may be disposed apart from each other, and thermal interference can be minimized.

Heat exchange may be performed while the refrigerant and a coolant pass through the first heat exchanger 20 and the second heat exchanger 60, respectively. In the embodiment, the heat exchangers and the valves are disposed as described above, but the present invention is not limited thereto. For example, only the heat exchangers may be coupled to the one surface of the manifold plate 1, and only the valves may be coupled to the other surface.

In the embodiment, a water-cooled condenser may be used as the first heat exchanger 20, and a chiller may be used as the second heat exchanger 60. The water-cooled condenser serves to condense a high-temperature and high-pressure gaseous fluid (the refrigerant) discharged from a compressor or an internal condenser into a high-pressure liquid through heat exchange with an external heat source. A chiller is a device in which a low-temperature and low-pressure fluid is supplied and heat-exchanged with a coolant moving in a coolant circulation line (not illustrated), and the cold coolant heat-exchanged in the chiller may circulate in the coolant circulation line and may be heat-exchanged with a battery.

Referring to FIG. 5, the first heat exchanger 20 has refrigerant ports through which a refrigerant is introduced and discharged. The refrigerant ports include a first refrigerant inlet 21 and a first refrigerant outlet 22 provided at upper and lower ends of the first heat exchanger 20, respectively. The first refrigerant inlet 21 is a portion through which the refrigerant passing through the first expansion valve 30 is introduced, and the first refrigerant outlet 22 is a portion through which the refrigerant heat-exchanged in the first heat exchanger 20 is discharged.

In the embodiment, the first refrigerant inlet 21 and the first refrigerant outlet 22 may be formed on a first refrigerant flange 20F integrally formed at one side of the first heat exchanger 20. The first refrigerant inlet 21 is disposed at a higher position than the first refrigerant outlet 22 so that the refrigerant can flow in a direction of gravity. Accordingly, a trapping phenomenon in which the refrigerant and oil are accumulated within the thermal management fluid module can be prevented.

In this case, in consideration of thermal interference, the first refrigerant inlet 21 may be formed at one side close to the first expansion valve 30, and the first refrigerant outlet 22 may be formed at the other side far from the first expansion valve 30. More specifically, the first refrigerant inlet 21 may be located closer to the first expansion valve 30 than the first refrigerant outlet 22. For example, a distance from the first expansion valve 30 to the first refrigerant inlet 21 may be smaller than a distance from the first expansion valve 30 to the first refrigerant outlet 22.

Referring to FIG. 6, the second heat exchanger 60 has refrigerant ports through which a refrigerant is introduced and discharged. The refrigerant ports include a second refrigerant inlet 61 and a second refrigerant outlet 62 provided at upper and lower ends of the second heat exchanger 60, respectively. The second refrigerant inlet 61 is a portion through which the refrigerant is introduced, and the second refrigerant outlet 62 is a portion through which the refrigerant heat-exchanged in the second heat exchanger 60 is discharged.

In the embodiment, the second refrigerant inlet 61 and the second refrigerant outlet 62 may be formed on a second refrigerant flange 60F integrally formed at one side of the second heat exchanger 60. The second refrigerant inlet 61 is located at a higher position than the second refrigerant outlet 62 so that the refrigerant can flow in the direction of gravity. Accordingly, the trapping phenomenon in which the refrigerant and oil are accumulated within the thermal management fluid module can be prevented.

In this case, in consideration of thermal interference, the second refrigerant inlet 61 of the second heat exchanger 60 may be formed at one side close to the second expansion valve 70, and the second refrigerant outlet 62 may be formed at the other side far from the second expansion valve 70. More specifically, the second refrigerant inlet 61 may be located closer to the second expansion valve 70 than the second refrigerant outlet 62. For example, a distance from the second expansion valve 70 to the second refrigerant inlet 61 may be smaller than a distance from the second expansion valve 70 to the second refrigerant outlet 62.

Referring again to FIG. 1, the first heat exchanger 20 has coolant ports through which a coolant is introduced and discharged. The coolant ports include a first coolant inlet 23 and a first coolant outlet 24 provided at the lower and upper ends of the first heat exchanger 20, respectively. The first coolant inlet 23 is a portion through which the coolant is introduced, and the first coolant outlet 24 is a portion through which the coolant heat-exchanged with the refrigerant is discharged. The coolant is heat-exchanged with the refrigerant while flowing in a direction (the lower portion→the upper portion) opposite to that of the refrigerant.

Since the above-described refrigerant ports and coolant ports are disposed separately from each other, assemblability of refrigerant pipes and coolant pipes can be improved.

The first expansion valve 30 serves to control expansion of the refrigerant flowing into the first heat exchanger 20. The first expansion valve 30 may be disposed around the first heat exchanger 20 and may expand or pass the refrigerant flowing into the thermal management fluid module for a vehicle. The refrigerant introduced through the first expansion valve 30 may be heat-exchanged while passing through the first heat exchanger 20 or may move to an external heat exchanger.

The refrigerant discharged through the first refrigerant outlet 22 of the first heat exchanger 20 flows into the first direction changing valve 40. The first direction changing valve 40 serves to control a direction of the refrigerant discharged from the first heat exchanger 20. The refrigerant flowing into the first direction changing valve 40 may move to an external heat exchanger (not illustrated). In addition, the refrigerant flowing into the first expansion valve 30 may move to the second direction changing valve 50 in a dehumidification mode and then to the evaporator (not illustrated).

A sensor 80 (for example, a PT sensor) that measures a temperature and pressure of the refrigerant may be disposed on the low-temperature flow path through which the refrigerant discharged from the second heat exchanger 60 flows. This is to detect an exact condition (the temperature and pressure) of the refrigerant discharged from the second heat exchanger 60 and improve controllability of a chiller expansion valve (not illustrated).

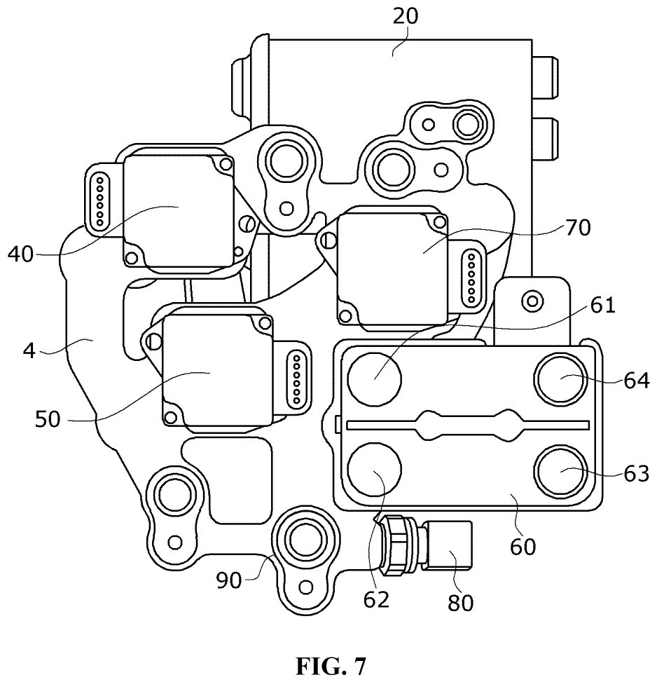

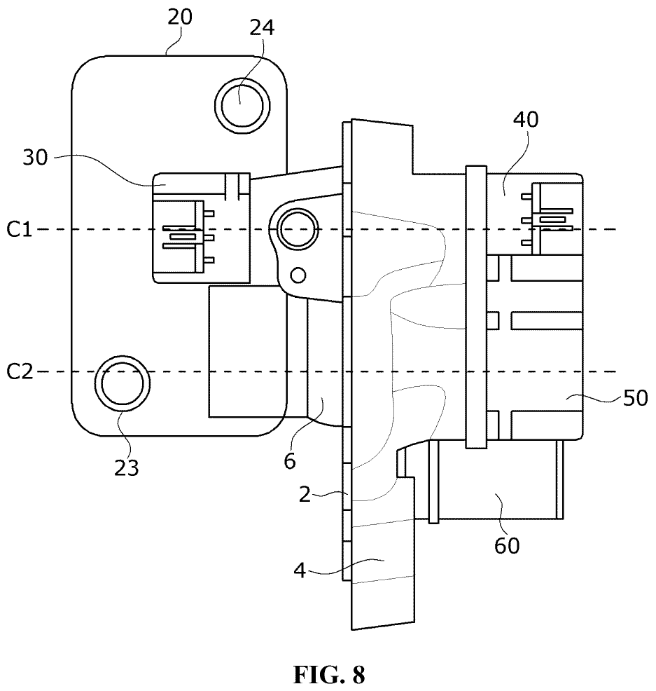

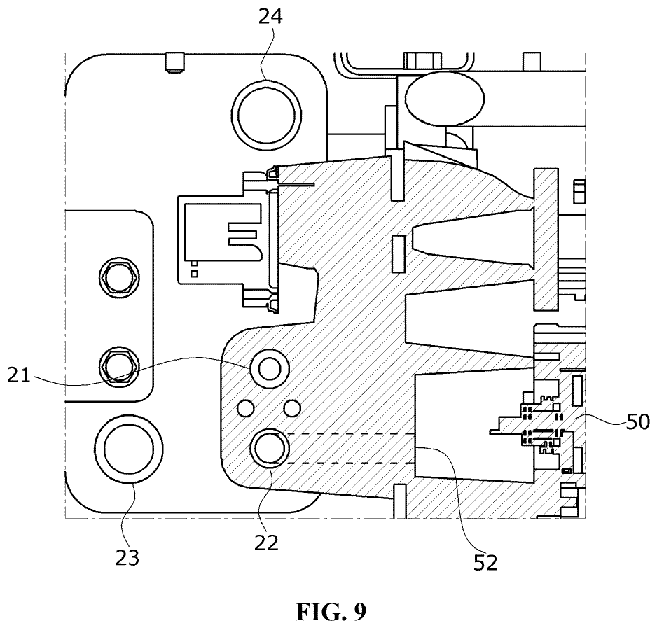

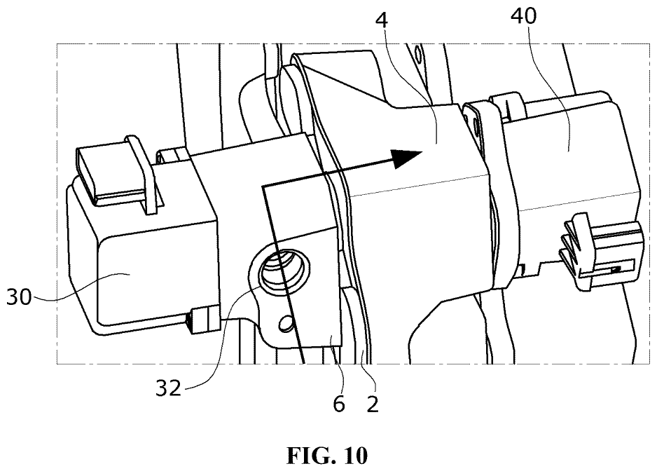

FIG. 7 is a front view illustrating the thermal management fluid module for a vehicle according to the embodiment of the present invention, FIG. 8 is a side view illustrating the thermal management fluid module for a vehicle according to the embodiment of the present invention, FIG. 9 is a drawing illustrating a fluid path between the first heat exchanger and the second direction changing valve in the thermal management fluid module for a vehicle according to the embodiment of the present invention, and FIG. 10 is a drawing illustrating a fluid flow path between the valves in the thermal management fluid module for a vehicle according to the embodiment of the present invention.

Referring to the drawings, since the first expansion valve 30 and the first direction changing valve 40 are disposed on both sides of the main plate 2, the first expansion valve 30 and the first direction changing valve 40 may be disposed on an extension line C1 that extends in a horizontal direction. That is, the refrigerant flowing into a valve inlet 32 of the first expansion valve 30 passes through the first expansion valve 30 and the communication hole 10 of the main plate 2 and flows into the first direction changing valve 40. By forming the refrigerant flow path in this way, a structure of the flow path can be simplified, pressure loss that occurs when the refrigerant passes through a relatively long flow path can be improved, and a package size of the fluid module can be reduced.

The first expansion valve 30 and the first direction changing valve 40 described above are examples, and any valves disposed on the first plate 4 and the second plate 6 of the main plate 2 can be configured to directly communicate the refrigerant flow path through the main plate 2.

Additionally, the first heat exchanger 20 is disposed on the second plate 6 based on the main plate 2, and the second direction changing valve 50 is disposed on the first plate 4. Therefore, the refrigerant discharged from the first heat exchanger 20 may pass through the communication hole 10 of the main plate 2 and flow directly into the second direction changing valve 50. In this case, the first heat exchanger 20 and the second direction changing valve 50 may be disposed on an extension line C2 that extends in the horizontal direction.

Referring to FIG. 9, the refrigerant discharged through the first refrigerant outlet 22 of the first heat exchanger 20 passes through the refrigerant flow path of the second plate 6 and the communication hole 10 of the main plate 2 and then flows directly into a valve inlet 52 formed in the second direction changing valve 50. By forming the refrigerant flow path in this way, the structure of the flow path can be simplified, the pressure loss that occurs when the refrigerant passes through a relatively long flow path can be improved, and the package size of the fluid module can be reduced.

The first heat exchanger 20 and the second direction changing valve 50 described above are examples, and any heat exchanger and valve may be configured to directly communicate the refrigerant flow path through the main plate 2 with the first plate 4 and the second plate 6, respectively, based on the main plate 2. That is, the first heat exchanger 20 may be configured so that the refrigerant flow path communicates with the first direction changing valve 40 and the second expansion valve 70 rather than the second direction changing valve 50.

The second heat exchanger 60 is supplied with low-temperature and low-pressure refrigerant and performs heat exchange with the coolant moving in the coolant circulation line (not illustrated). The cold coolant heat-exchanged in the second heat exchanger 60 may circulate in the coolant circulation line and may be heat-exchanged with the battery. The refrigerant heat-exchanged with an external heat exchanger flows into the second expansion valve 70, and the refrigerant expanded in the second expansion valve 70 flows into the second heat exchanger 60. The refrigerant heat-exchanged in the second heat exchanger 60 is discharged through the lower end and flows into an accumulator (not illustrated).

Additionally, referring to FIG. 7, an accumulator port 90, which is a port through which a refrigerant flows out of the thermal management fluid module for a vehicle, is provided at the lowest end in the direction of gravity, thereby preventing the trapping phenomenon in which the refrigerant and oil are accumulated within the thermal management fluid module.

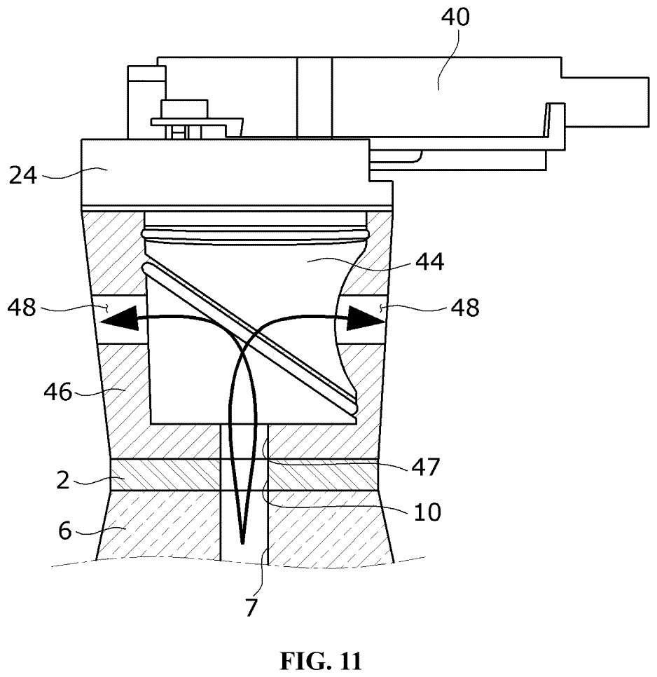

FIG. 11 is a cross-sectional view illustrating the thermal management fluid module for a vehicle equipped with the first direction changing valve according to the embodiment of the present invention.

With reference to the drawing, a valve mounting portion 46 on which the first direction changing valve 40 is seated and coupled may be formed on the first plate 4. The valve mounting portion 46 may be formed in a substantially cylindrical shape corresponding to a shape of the first direction changing valve 40. The valve mounting portion 46 is actually formed integrally with the first plate 4.

In the embodiment, a three-way valve may be used as the first direction changing valve 40. Since the refrigerant is discharged to both sides of the lower end, through which the refrigerant is introduced, of the first direction changing valve (40), an inlet hole 47 and an outlet hole 48 are formed to correspond thereto in the valve mounting portion 46.

The inlet hole 47 is formed in a bottom surface of the valve mounting portion 46 so that the refrigerant flowing through the second plate 6 can be directly introduced. That is, the refrigerant flowing through the second flow path 7 of the second plate 6 is directly introduced through the communication hole 10 of the main plate 2. Such an introduced refrigerant may be selectively discharged to either side of the first direction changing valve 40. The discharged refrigerant may flow along the first flow path 5 formed in the first plate 4 through the outlet hole 48 of the valve mounting portion 46.

Meanwhile, the first direction changing valve 40 may be provided with a flange portion 42 on the upper portion thereof for fastening to the manifold plate 1. The flange portion 42 may be formed in a disc shape on the upper portion of the first direction changing valve 40 and may be fastened to the valve mounting portion 46 using a bolt or the like. Additionally, the first direction changing valve 40 includes a valve housing 44 having a ball mounted therein for controlling a flow direction of the refrigerant.

The first direction changing valve 40 illustrated in the drawing is a ball type three-way valve, and since a portion through which the refrigerant is introduced is formed at the lower end, the refrigerant may be directly introduced from the second plate 6 on the opposite side as described above. Of course, any valve, such as a needle-type valve, may be applied as long as it has a structure in which the refrigerant can be directly introduced from the second plate 6.

By forming the refrigerant flow path in this way, the structure of the flow path can be simplified, the pressure loss that occurs when the refrigerant passes through a relatively long flow path can be improved, and the package size of the fluid module can be reduced.

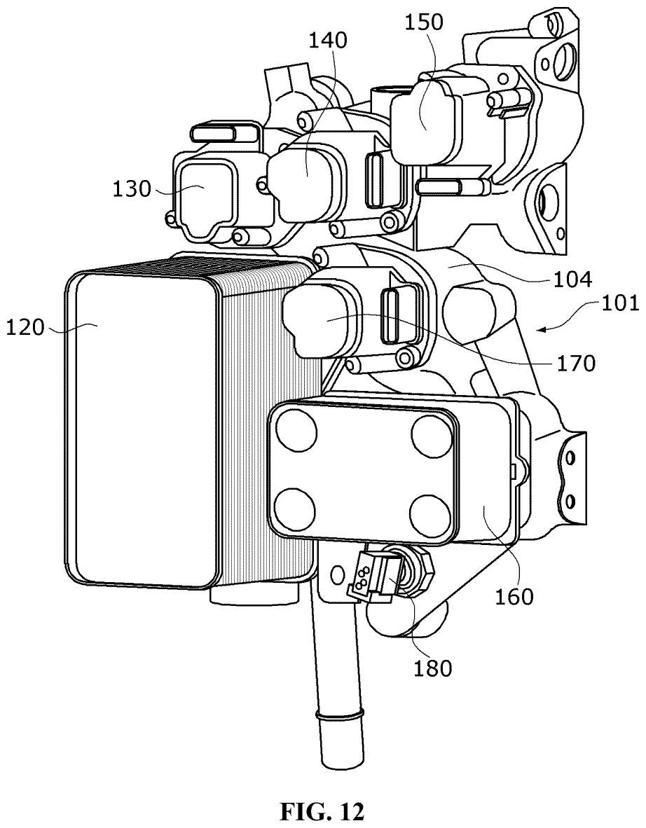

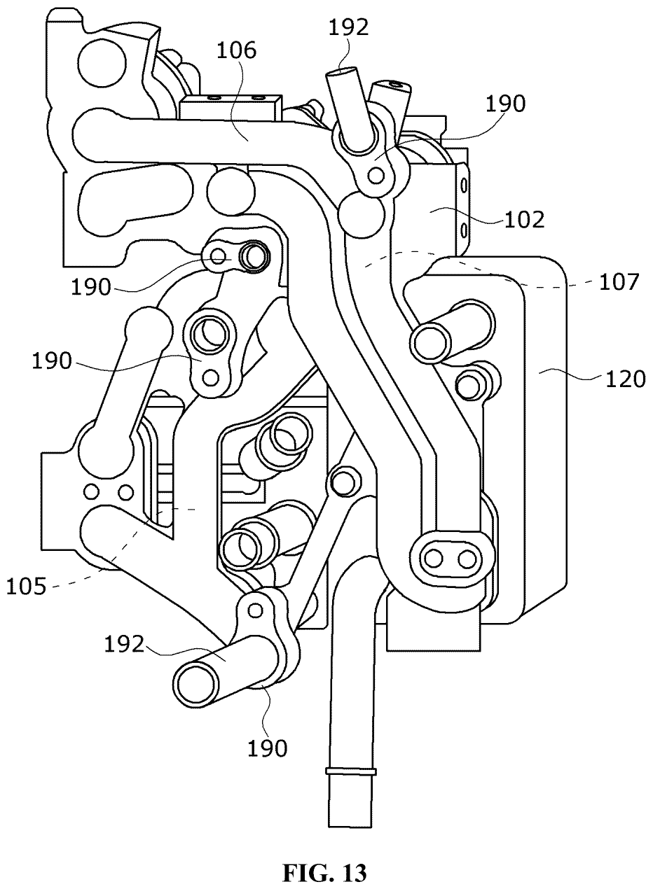

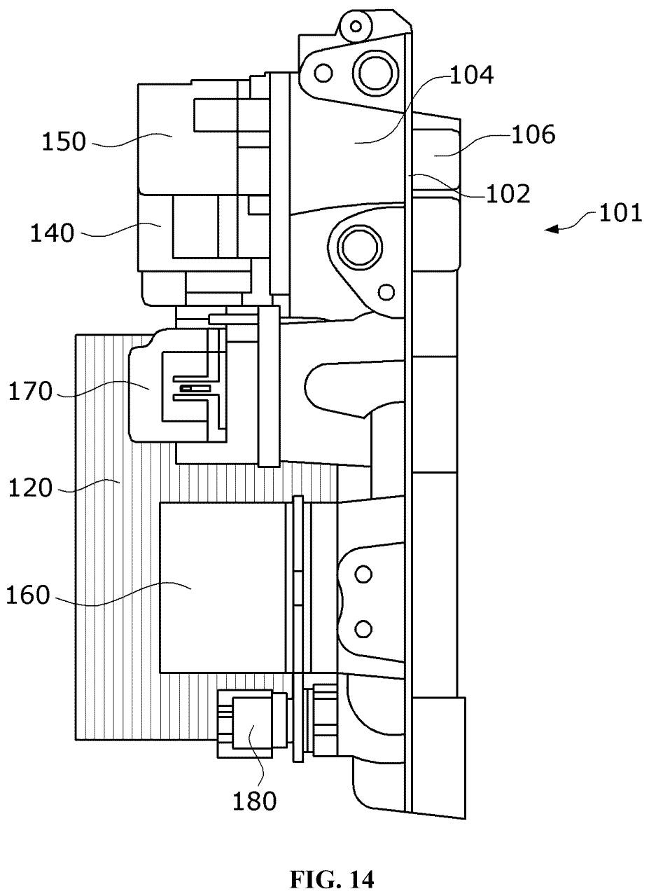

FIG. 12 is a perspective view illustrating a thermal management fluid module for a vehicle according to another embodiment of the present invention, FIG. 13 is a perspective view illustrating a rear surface of the thermal management fluid module for a vehicle according to another embodiment of the present invention, and FIG. 14 is a side view of the thermal management fluid module for a vehicle according to another embodiment of the present invention.

As illustrated, the thermal management fluid module for a vehicle according to the embodiment of the present invention includes a manifold plate 101 in which a flow path for a flow of a fluid is formed, heat exchangers 120 and 160 that is coupled to one surface of the manifold plate 101 and performs heat exchange while the fluid flows, and a valve that is coupled to the one surface of the manifold plate 101 and expands the fluid or controls a direction of the fluid, and a fluid flowing in the other surface of the manifold plate 101 may directly flow into the valve coupled to the one surface of the manifold plate 101.

The manifold plate 101 has substantially a plate shape with a predetermined thickness and a fluid path formed therein. In this way, since the first heat exchanger 120, the second heat exchanger 160, the expansion valves 130 and 170, and the direction changing valves 140 and 150 which are heat exchange devices of the heat management system are coupled and modularized on the manifold plate 101, a product manufacturing work is reduced and a work in a vehicle assembly line can also be reduced. In addition, the manifold plate 101 performs functions of piping, fitting, and housing simultaneously, thereby reducing production cost and improving workability.

The manifold plate 101 may include a main plate 102, a first plate 104 that is coupled to one surface of the main plate 102 and in which a flow path through which a fluid flows is formed, and a second plate 106 that is coupled to the other surface of the main plate 102 and in which a flow path through which a fluid flows is formed. The manifold plate 101 includes an assembly configured of the above-described plates and may be manufactured by coupling the plates using brazing, structural adhesives, gaskets, or the like. Additionally, various materials such as aluminum, thermoplastic, stainless steel, and the like may be applied to the manifold plate 101 according to manufacturing methods, purposes, and functions thereof.

The main plate 102 is formed in a plate shape, and the first plate 104 may be coupled on the one surface of the main plate 102, and the second plate 106 may be coupled on the other surface. A fluid flow path is formed between the main plate 102 and a part formed by coupling the first plate 104 and the second plate 106 to protrude to a predetermined thickness. According to the manifold plate 101 formed by the coupling described above, heat exchangers, valves, and the like may be coupled on both surfaces of the main plate 102, the fluid flow paths may be formed therein, and thus modularization of components is possible in a more compact space.

A first flow path 105 through which a refrigerant flows may be formed inside the first plate 104, and a second flow path 107 through which a refrigerant flows may be formed inside the second plate 106. Accordingly, the refrigerant can flow in the first plate 104 and the second plate 106 disposed on both sides of the main plate 102.

In the embodiment, the components such as valves having a relatively high after-service frequency are disposed on the one surface of the manifold plate 101 corresponding to the side opposite to an engine room, that is, on a front surface, and thus a worker can easily perform after-service by separating only the corresponding valve from the manifold plate 101 when the after-service is performed. In addition, the components such as pipes 192 and the like, which have a relatively low after-service frequency, are disposed on the other surface of the manifold plate 101, that is, a rear surface, corresponding to a surface facing the engine room, and thus the space is configured compactly. In addition, connection flanges 190 may be provided at several positions on the other surface of the manifold plate 101 so that the pipes 192 and the refrigerant flow paths can directly communicate with each other.

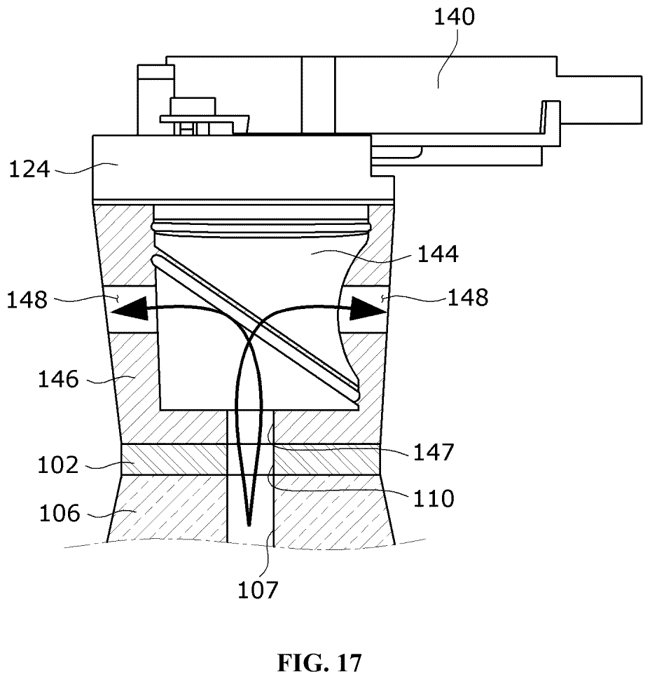

Referring to FIG. 17, a communication hole 110 for flow path communication between the valves coupled to the first plate 104 may be formed in the main plate 102. The communication hole 110 may be formed anywhere other than in the portion illustrated in the drawing, as long as it is a portion through which the refrigerant flow path between the valves communicates.

Referring again to FIG. 12, each of a first heat exchanger 120, a second heat exchanger 160, a first expansion valve 130, a second expansion valve 170, a first direction changing valve 140, and a second direction changing valve 150 is coupled to the one surface (the first plate 104) of the manifold plate 101. That is, in the embodiment, both the heat exchangers 120 and 160 and the valves, which are components of the thermal management fluid module for a vehicle, may be coupled on the first plate 104. In addition, the second plate 106 may be configured to form only the flow path for a flow of a fluid. In this way, optimal modularization can be achieved by arranging the components on only the one surface of the manifold plate 101.

The flow path through which the refrigerant that is heat-exchanged in the first heat exchanger 120 and then discharged flows into the first direction changing valve 140 may be a high-temperature flow path, and the flow path through which the refrigerant heat-exchanged in the second heat exchanger 160 is discharged may be a low-temperature flow path. However, as described above, when the first heat exchanger 120 and the second heat exchanger 160 are respectively disposed on one surface and the other surface of the manifold plate 101, the high-temperature flow path and the low-temperature flow path may be disposed apart from each other, and thus thermal interference can be minimized.

Heat exchange may be performed in the first heat exchanger 120 and the second heat exchanger 160 while the refrigerant and the coolant as heat exchange fluids pass through the first heat exchanger 120 and the second heat exchanger 160, respectively. In the embodiment, a water-cooled condenser may be used as the first heat exchanger 120, and a chiller may be used as the second heat exchanger 160. The water-cooled condenser serves to perform heat exchange with an external heat source and condense a high-temperature and high-pressure gaseous fluid (refrigerant) discharged from a compressor or internal condenser into a high-pressure liquid. The chiller is a device in which a low-temperature and low-pressure fluid is supplied and heat-exchanged with a coolant moving in a coolant circulation line (not illustrated). The cold coolant heat-exchanged in the chiller may circulate in the coolant circulation line and may be heat-exchanged with the batteries.

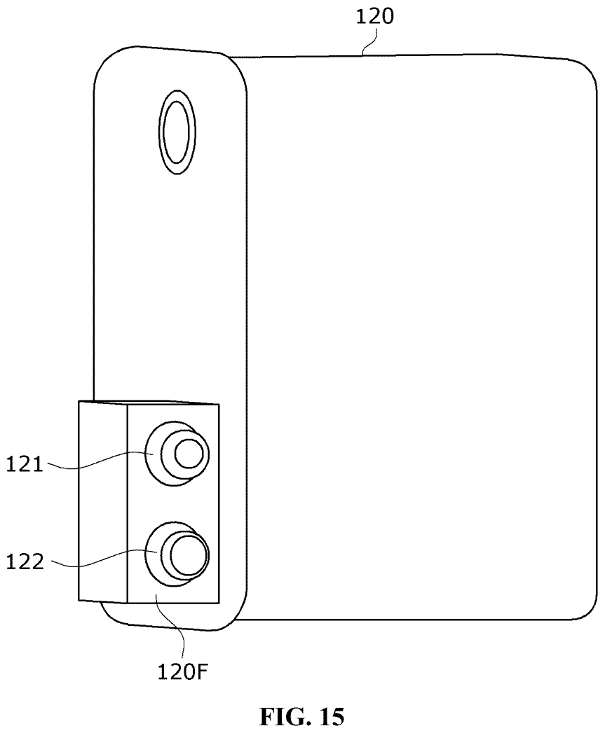

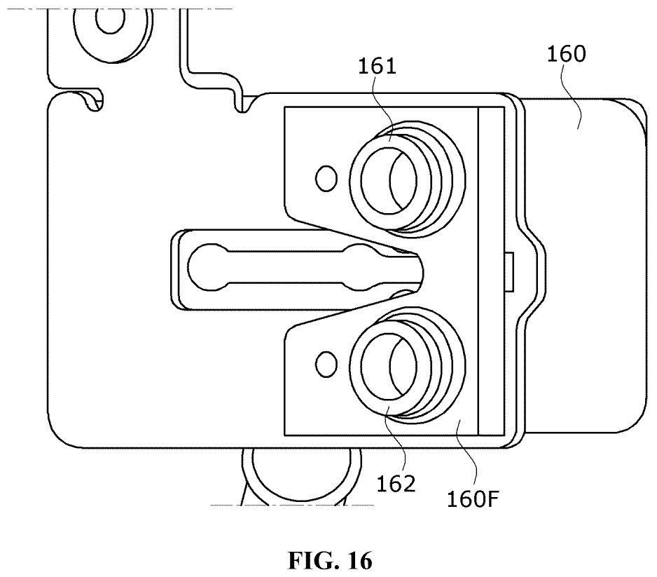

FIG. 15 is a perspective view illustrating the first heat exchanger of the thermal management fluid module for a vehicle according to another embodiment of the present invention, and FIG. 16 is a perspective view illustrating the second heat exchanger of the thermal management fluid module for a vehicle according to another embodiment of the present invention.

Referring to FIG. 15, the first heat exchanger 120 is provided with refrigerant ports through which a refrigerant is introduced and discharged. The refrigerant ports include a first refrigerant inlet 121 and a first refrigerant outlet 122 provided at upper and lower ends of the first heat exchanger 120, respectively. The first refrigerant inlet 121 is a portion through which the refrigerant passing through the first expansion valve 130 is introduced, and the first refrigerant outlet 122 is a portion through which the refrigerant heat-exchanged in the first heat exchanger 120 is discharged.

In the embodiment, the first refrigerant inlet 121 and the first refrigerant outlet 122 may be formed on a first refrigerant flange 120F integrally formed on one side of the first heat exchanger 120. The first refrigerant inlet 121 is located at a higher position than the first refrigerant outlet 122 so that the refrigerant can flow in the direction of gravity. Accordingly, the trapping phenomenon in which a refrigerant and oil are accumulated within the thermal management fluid module can be prevented.

In this case, in consideration of thermal interference, the first refrigerant inlet 121 may be formed on one side close to the first expansion valve 130, and the first refrigerant outlet 122 may be formed on the other side far from the first expansion valve 130. More specifically, the first refrigerant inlet 121 may be located closer to the first expansion valve 130 than the first refrigerant outlet 122. For example, a distance from the first expansion valve 130 to the first refrigerant inlet 121 may be smaller than a distance from the first expansion valve 130 to the first refrigerant outlet 122.

Referring to FIG. 16, the second heat exchanger 160 is provided with refrigerant ports through which a refrigerant is introduced and discharged. The refrigerant ports include a second refrigerant inlet 161 and a second refrigerant outlet 162 provided at upper and lower ends of the second heat exchanger 160, respectively. The second refrigerant inlet 161 is a portion through which the refrigerant is introduced, and the second refrigerant outlet 162 is a portion through which the refrigerant heat-exchanged in the second heat exchanger 160 is discharged.

In the embodiment, the second refrigerant inlet 161 and the second refrigerant outlet 162 may be formed on a second refrigerant flange 160F integrally formed on one side of the second heat exchanger 160. The second refrigerant inlet 161 is located at a higher position than the second refrigerant outlet 162 so that the refrigerant can flow in the direction of gravity. Accordingly, the trapping phenomenon in which the refrigerant and oil are accumulated within the thermal management fluid module can be prevented.

In this case, in consideration of thermal interference, the second refrigerant inlet 161 of the second heat exchanger 160 may be formed on one side close to the second expansion valve 170, and the second refrigerant outlet 162 may be formed on the other side far from the second expansion valve 170. More specifically, the second refrigerant inlet 161 may be located at a position closer to the second expansion valve 170 than that of the second refrigerant outlet 162. For example, a distance from the second expansion valve 170 to the second refrigerant inlet 161 may be smaller than a distance from the second expansion valve 170 to the second refrigerant outlet 162.

Referring again to FIG. 12, the first expansion valve 130 serves to control expansion of the refrigerant introduced into the first heat exchanger 120. The first expansion valve 130 may be disposed around the first heat exchanger 120 and may expand or pass the refrigerant flowing into the thermal management fluid module for a vehicle. The refrigerant introduced through the first expansion valve 130 may be heat-exchanged while passing through the first heat exchanger 120 or may move to an external heat exchanger.

The refrigerant discharged through the first refrigerant outlet 122 of the first heat exchanger 120 flows into the first direction changing valve 140. The first direction changing valve 140 serves to control a direction of the refrigerant discharged from the first heat exchanger 120. The refrigerant flowing into the first direction changing valve 140 may move to an external heat exchanger (not illustrated). In addition, the refrigerant flowing into the first expansion valve 130 may move to the second direction changing valve 150 in the dehumidification mode and then to an evaporator (not illustrated).

A sensor 180 (for example, a PT sensor) that measures a temperature and pressure of the refrigerant may be disposed on the low-temperature flow path through which the refrigerant discharged from the second heat exchanger 160 flows. This is to detect an exact state (the temperature and pressure) of the refrigerant discharged from the second heat exchanger 160 and improve controllability of a chiller expansion valve (not illustrated). In the embodiment, the sensor 180 may be coupled to one surface of the manifold plate 101, that is, the first plate 104. That is, the sensor 180 may be coupled together with other components to one surface of the manifold plate 101.

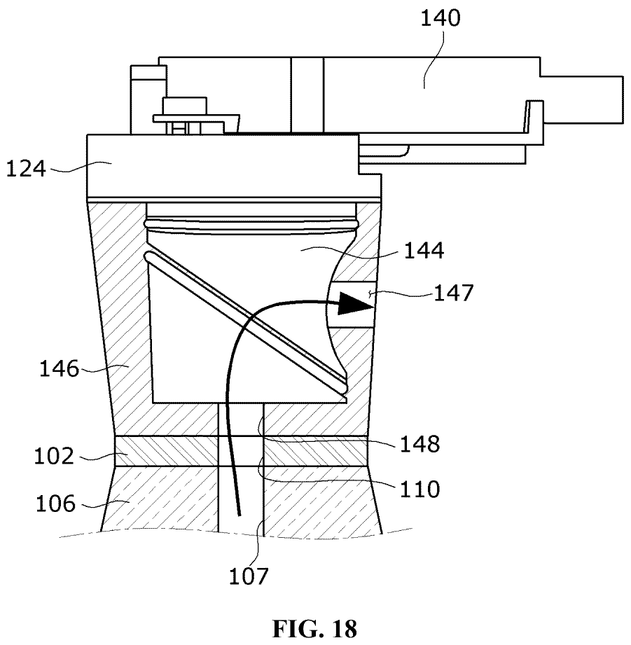

FIG. 17 is a cross-sectional view illustrating an example of the thermal management fluid module for a vehicle equipped with a first direction changing valve according to another embodiment of the present invention, and FIG. 18 is a cross-sectional view illustrating another example of the thermal management fluid module for a vehicle equipped with the first direction changing valve according to another embodiment of the present invention. The first direction changing valve 140 illustrated in the drawings is described as an example and can also be applied to various valves coupled to the thermal management fluid module for a vehicle.

With reference to the drawings, a valve mounting portion 146 on which the first direction changing valve 140 is seated and coupled may be formed on the first plate 104. The valve mounting portion 146 may be formed in an approximately cylindrical shape corresponding to a shape of the first direction changing valve 140. The valve mounting portion 146 is actually formed integrally with the first plate 104.

In the embodiment, a three-way valve may be used as the first direction changing valve 140. Since the refrigerant is discharged to both sides of the lower end, through which the refrigerant is introduced, of the first direction changing valve 140, an inlet hole 147 and an outlet hole 148 are formed to correspond thereto in the valve mounting portion 146.

The inlet hole 147 is formed in a bottom surface of the valve mounting portion 146 so that the refrigerant flowing through the second plate 106 can be directly introduced. That is, the refrigerant flowing through the second flow path 107 of the second plate 106 is directly introduced through the communication hole 110 of the main plate 102. Referring to FIG. 17, such an introduced refrigerant may be selectively discharged to either side of the first direction changing valve 140. The discharged refrigerant may flow along the first flow path 105 formed in the first plate 104 through the outlet hole 148 of the valve mounting portion 146.

Referring to FIG. 18, the inlet hole 147 may be formed only in one side of the valve mounting portion 146 so that a refrigerant may be introduced, and the outlet hole 148 may be formed in the bottom surface of the valve mounting portion 146 so that a refrigerant may be discharged.

Meanwhile, the first direction changing valve 140 may be provided with a flange portion 142 on the upper portion thereof for fastening to the manifold plate 101. The flange portion 142 may be formed in a disc shape on the upper portion of the first direction changing valve 140 and may be fastened to the valve mounting portion 146 using a bolt or the like. Additionally, the first direction changing valve 140 includes a valve housing 144 having a ball mounted therein for controlling the flow direction of the refrigerant.

The first direction changing valve 140 illustrated in this drawing is a ball type three-way valve, and since a portion through which the refrigerant is introduced is formed at the lower end, the refrigerant may be directly introduced from the second plate 106 on the opposite side as described above. Of course, any valve, such as a needle-type valve, may be applied as long as it has a structure in which the refrigerant can be directly introduced from the second plate 106.

By forming the refrigerant flow path in this way, the structure of the flow path can be simplified, the pressure loss that occurs when the refrigerant passes through a relatively long flow path can be improved, and the package size of the fluid module can be reduced.

Although the present invention has been described above with reference to specific embodiments thereof, it will be understood by those skilled in the art that various modifications and changes may be made to the present invention without departing from the spirit and scope of the present invention as set forth in the claims below.

Reference Signs List

```
  1: Manifold plate
  2: Main plate
  4: First plate
  5: First flow path
  6: Second plate
  7: Second flow path
  10: Communication hole
  20: First heat exchanger
  21: First refrigerant inlet
  22: First refrigerant outlet
  23: First coolant inlet
  24: First coolant outlet
  30: First expansion valve
  32: Refrigerant inlet
  40: First direction changing valve
  42: Flange portion
  44: Valve housing
  46: Valve mounting portion
  47: Inlet hole
  48: Outlet hole
  50: Second direction changing valve
  52: Valve inlet
  60: Second heat exchanger
  61: Second refrigerant inlet
  62: Second refrigerant outlet
  63: Second coolant inlet
  64: Second coolant outlet
  70: Second expansion valve
  80: Sensor
  90: Accumulator port
101: Manifold plate
102: Main plate
104: First plate
105: First flow path
106: Second plate
107: Second flow path
110: Communication hole
120: First heat exchanger
121: First refrigerant inlet
122: First refrigerant outlet
130: First expansion valve
140: First direction changing valve
142: Flange portion
144: Valve housing
146: Valve mounting portion
147: Inlet hole
148: Outlet hole
150: Second direction changing valve
160: Second heat exchanger
161: Second refrigerant inlet
162: Second refrigerant outlet
170: Second expansion valve
180: Sensor
190: Connection flange
192: Pipe
```

1. A thermal management fluid module for a vehicle, comprising:
a manifold plate in which a flow path through which a fluid flows is formed;
a heat exchanger coupled to one surface of the manifold plate; and
a valve coupled to the other surface of the manifold plate and configured to expand the fluid or control a direction of the fluid,
wherein the fluid discharged from the heat exchanger directly flows to the valve.

2. The thermal management fluid module for a vehicle of claim 1, wherein the manifold plate includes:
a main plate;
a first plate that is coupled to one surface of the main plate and in which a flow path through which a fluid flows is formed; and
a second plate that is coupled to the other surface of the main plate and in which a flow path through which a fluid flows is formed,
wherein a communication hole for flow path communication between the heat exchanger and the valve which are respectively coupled to the first plate and the second plate is formed in the main plate.

3. (canceled)

4. The thermal management fluid module for a vehicle of claim 2, wherein a fluid outlet through which the fluid is discharged from the heat exchanger is disposed on an extension line that extends in a horizontal direction from a valve inlet through which the fluid is introduced from the valve.

5. The thermal management fluid module for a vehicle of claim 1, wherein a first heat exchanger which performs heat exchange while the fluid flows, and a first expansion valve that expands the fluid flowing into the first heat exchanger or passes the fluid are coupled to the second plate.

6. The thermal management fluid module for a vehicle of claim 5, wherein a second heat exchanger which performs heat exchange while the fluid flows, a first direction changing valve and a second direction changing valve that control a direction of the fluid discharged from the first heat exchanger, and a second expansion valve that expands the fluid flowing into the second heat exchanger are coupled to the first plate.

7. The thermal management fluid module for a vehicle of claim 2, wherein a first heat exchanger through which a high-temperature fluid flows is coupled to the second plate, and a second heat exchanger through which a low-temperature fluid flows is coupled to the first plate.

8. The thermal management fluid module for a vehicle of claim 6, wherein the first heat exchanger is disposed so that the fluid directly flows to the first direction changing valve or the second direction changing valve.

9. The thermal management fluid module for a vehicle of claim 8, wherein a first refrigerant outlet of the first heat exchanger is disposed on an extension line that extends in a horizontal direction from a valve inlet of the second direction changing valve.

10-12. (canceled)

13. A thermal management fluid module for a vehicle, comprising:
a manifold plate in which a flow path through which a fluid flows is formed; and
a valve coupled to one surface of the manifold plate and configured to expand the fluid or control a direction of the fluid,
wherein the fluid flowing in the other surface of the manifold plate flows directly into the valve coupled to the one surface of the manifold plate.

14. The thermal management fluid module for a vehicle of claim 13, wherein the manifold plate includes:
a main plate;
a first plate that is coupled to one surface of the main plate and in which a flow path through which a fluid flows is formed; and
a second plate that is coupled to the other surface of the main plate and in which a flow path through which a fluid flows is formed,
wherein a communication hole for flow path communication between the heat exchanger and the valve which are respectively coupled to the first plate and the second plate is formed in the main plate.

15. (canceled)

16. The thermal management fluid module for a vehicle of claim 14, wherein the valve is seated and coupled on a valve mounting portion provided on the first plate, and an inlet hole that communicates with the communication hole is formed in the valve mounting portion.

17. The thermal management fluid module for a vehicle of claim 16, wherein outlet holes through which the fluid introduced through the inlet hole is discharged are formed on both sides of the valve mounting portion.

18. The thermal management fluid module for a vehicle of claim 14, wherein a first heat exchanger which performs heat exchange while the fluid flows, and a first expansion valve that expands the fluid flowing into the first heat exchanger or passes the fluid are coupled to the second plate.

19. The thermal management fluid module for a vehicle of claim 18, wherein a second heat exchanger which performs heat exchange while the fluid flows, a first direction changing valve and a second direction changing valve that control the direction of the fluid discharged from the first heat exchanger, and a second expansion valve that expands the fluid flowing into the second heat exchanger are coupled to the first plate.

20. The thermal management fluid module for a vehicle of claim 14, wherein a first heat exchanger through which a high-temperature fluid flows is coupled to the second plate, and a second heat exchanger through which a low-temperature fluid flows is coupled to the first plate.

21-23. (canceled)

24. A thermal management fluid module for a vehicle, comprising:
a manifold plate in which a flow path through which a fluid flows is formed;
a heat exchanger that is coupled to one surface of the manifold plate and which performs heat exchange while the fluid flows; and
a valve coupled to the one surface of the manifold plate and configured to expand the fluid or control a direction of the fluid,
wherein the fluid flowing in the other surface of the manifold plate flows directly into the valve coupled to the one surface of the manifold plate.

25. The thermal management fluid module for a vehicle of claim 24, wherein the manifold plate includes:
a main plate;
a first plate that is coupled to one surface of the main plate and in which a flow path through which a fluid flows is formed; and
a second plate that is coupled to the other surface of the main plate and in which a flow path through which a fluid flows is formed,
wherein a communication hole for flow path communication between the heat exchanger and the valve which are respectively coupled to the first plate and the second plate is formed in the main plate.

26. (canceled)

27. The thermal management fluid module for a vehicle of claim 25, wherein the valve is seated and coupled on a valve mounting portion provided on the first plate, and an inlet hole that communicates with the communication hole is formed in the valve mounting portion.

28. The thermal management fluid module for a vehicle of claim 27, wherein outlet holes through which the fluid introduced through the inlet hole is discharged are formed on both sides of the valve mounting portion.

29. The thermal management fluid module for a vehicle of claim 25, wherein the valve is seated and coupled on a valve mounting portion provided on the first plate, and an inlet hole through which the fluid is introduced is formed at one side of the valve mounting portion.

30-34. (canceled)
